(19) United States
(12) Patent Application Publication
(10) Pub. No.: US 2026/0055555 A1
(43) Pub. Date: Feb. 26, 2026

(54) PAPER-BASED PACKAGING FILMS HAVING MULTILAYER BARRIER FILM

(71) Applicant: AMCOR FLEXIBLES NORTH AMERICA, INC., NEENAH, WI (US)

(72) Inventors: Peter ETTRIDGE, Worcester (GB); Nils DE RYBEL, Destelbergen (BE); Ross K. GRUETZMACHER, Neenah, WI (US); Marcelo Brasil ELIAS, Appleton, WI (US); Peter HANSEN, Vejle Oest (DK); Philipp OKLE, Konstanz (DE)

(21) Appl. No.: 19/105,293

(22) PCT Filed: Sep. 8, 2022
(86) PCT No.: PCT/US2022/042850

§ 371 Date: Feb. 20, 2025

(51) Int. Cl. D21H 27/10; D21H 19/22; D21H 19/82

(52) U.S. Cl. CPC D21H 27/10; D21H 19/22; D21H 19/82

(57) ABSTRACT

This disclosure relates to paper-based packaging films and methods of producing the same. The paper-based packaging films have a total composition comprising greater than or equal to 80%, by weight, of a paper component and less than or equal to 5%, by weight, of non-compostable materials. The paper-based packaging films are easily recyclable by repulping yet retain high-performance packaging characteristics including improved barrier performance and high run speed on packaging equipment.

### TECHNICAL FIELD

The present disclosure is related to paper-based packaging films and methods of producing the same. Embodiments of the present disclosure are directed to paper-based packaging films comprising greater than or equal to 80%, by weight.

### BACKGROUND

The goal of increasing recyclability of paper-based packaging films becomes challenging when attempting to form packaging films having improved barrier properties. Traditionally, improved barrier properties are achieved in paper-based packaging films by forming a polymeric multilayer film. Multilayer films contain a plurality of layers specific to forming barrier layers. As performance demands increase, the multitude of layers or thickness of the layers in the multilayer film increase, working against the recyclability of the structure as the paper content decreases on a percentage basis.

Often, when high performance is desired from paper-based packaging films, relatively high amounts of additional non-paper materials are added to the paper-based packaging films (e.g., structures having improved barrier properties). To maintain recyclability of the paper-based packaging film, the paper component thickness and/or weight is increased in order to attain the paper content required for designating the packaging material “recyclable.” This additional paper thickness/weight may be problematic in that the additional bulk of the packaging film may lead to processing issues on package forming equipment. The increased thickness and stiffness of the film often leads to slow lines speeds as the film is more difficult to pull through forming collars. The packaging film may also be more difficult to seal because the additional paper weight tends to absorb the heat of the sealing bars and/or prohibit evenly distributed pressure application.

Without contesting the associated advantages of the state-of-the-art systems, there exists a need for high-barrier paper-based packaging films suitable for both recycling and composting.

### SUMMARY

Embodiments of the disclosure are directed to flexible, paper-based packaging films having improved barrier properties and excellent sealing performance, while maintaining recyclability in a paper recycling process. The paper-based packaging films comprise a paper component, a barrier layer, a compostable polymer, and include minimal amounts of non-compostable materials (i.e., minimal amounts of non-paper and non-compostable polymer materials). The paper-based packaging films advantageously provide at least two end-of-life options: (1) a paper recycling (repulpability) process and/or (2) a compost process.

In some embodiments, a total composition of the paper-based packaging film comprises greater than or equal to 80%, greater than or equal to 85%, greater than or equal to 90% or greater than or equal to 95%, by weight, of the paper component.

In some embodiments, the paper-based packaging film comprises less than or equal to 5%, by weight, of non-compostable materials.

In some embodiments, the paper component has a basis weight in a range of from 30 g/m² to 360 g/m².

In some embodiments, the paper-based packaging film comprises a multilayer barrier film attached to the paper component. In some embodiments, the paper-based packaging film comprises an adhesive layer attaching the multilayer barrier film to the paper component. In some embodiments, the multilayer barrier film and the adhesive layer have a combined thickness of less than or equal to 10 μm. In some embodiments, the combined thickness is in a range of from 4 μm to 8 μm.

In some embodiments, the multilayer barrier film comprises a transfer substrate and a barrier layer deposited thereon by physical vapor deposition (PVD). In some embodiments, the transfer substrate comprises a heat seal layer, and optionally a lacquer layer.

In some embodiments, the heat seal layer comprises a non-oriented film. In some embodiments, the heat seal layer comprises a compostable polymer. In some embodiments, the heat seal layer comprises one or more of: polylactic acid (PLA), polybutylene adipate terephthalate (PBAT), polybutylene succinate (PBS), polyhydroxyalkanoate (PHA), and/or polyvinyl alcohol (PVOH).

In some embodiments, the heat seal layer has a thickness in a range of from 2 μm to 10 μm, including all values and subranges therebetween. In some embodiments, the heat seal layer has a thickness in a range of from 2 μm to 8 μm, or in a range of from 2 μm to 6 μm. In some embodiments, the heat seal layer is directly connected to the barrier layer.

In some embodiments, the transfer substrate further comprises a lacquer layer. The lacquer layer may be located between the barrier layer and the heat seal layer. In some embodiments, the lacquer layer comprises one or more of: polyurethane (PU), polyvinyl alcohol (PVOH), and/or ethylene vinyl alcohol (EVOH). In some embodiments, the lacquer layer has a thickness in a range of from 1 μm to 2 μm.

In some embodiments, the barrier layer comprises one or more of: a metal, a metal oxide, and/or an inorganic oxide. In some embodiments, the barrier layer comprises one or more of: aluminum (Alu), aluminum oxide (AIOx) and/or silicon oxide (SiOx).

Additional embodiments are directed to a method of producing a paper-based packaging film. In some embodiments, the method comprises: coating a base web having a thickness in a range of from 6 μm to 50 μm with a multilayer barrier film; attaching the multilayer barrier film to a paper component by a lamination process to form an intermediate structure; and removing the base web from the intermediate structure to yield the paper-based packaging film.

In some embodiments, a single transfer operation comprises: the attaching of the multilayer barrier film to the paper component, and the removing of the base web from the intermediate structure. In some embodiments, the attaching of the multilayer barrier film to the paper component, and the removing of the base web from the intermediate structure are performed as separate operations.

The base film may be an oriented film (monoaxial or biaxial orientation) or an unoriented film (i.e., a blown film or cast film without orientation). In some embodiments, the base web comprises one or more of: an oriented polyethylene (OPE) film, an oriented polyethylene terephthalate (OPET) film, an oriented polypropylene (OPP) film, and/or an oriented polyamide (OPA) film.

In some embodiments, the coating of the base web comprises depositing a transfer substrate on the base web and depositing a barrier layer by physical vapor deposition (PVD) on the transfer substrate, a combination of the barrier layer and the transfer substrate defining the multilayer barrier film.

In some embodiments, the attaching of the multilayer barrier film to the paper component comprises disposing an adhesive layer between the multilayer barrier film and the paper component.

In other embodiments, the method of producing the paper-based packaging film comprises producing a base web and a heat seal layer by coextrusion; depositing a barrier layer on the heat seal layer by physical vapor deposition (PVD); attaching the barrier layer to a paper component by a lamination process to form an intermediate structure; and removing the base web from the intermediate structure to expose the heat seal layer and yield the paper-based packaging film.

### BRIEF DESCRIPTION OF THE DRAWINGS

The disclosure may be more completely understood in consideration of the following detailed description of various embodiments of the disclosure in connection with the accompanying Figures, in which:

FIG. 1 illustrates a process flow diagram of a method of producing a paper-based packaging film according to one or more embodiments;

FIG. 2 illustrates a process flow diagram of a method of producing a paper-based packaging film according to one or more embodiments; and

FIGS. 3, 4, and 5 are schematic cross-sectional views of film structures in intermediate steps of forming a paper-based packaging film.

FIGS. 6 and 7 are schematic cross-sectional views of embodiments of the final paper-based packaging film.

The Figures show some, but not all embodiments. The elements depicted in the Figures are illustrative and not necessarily to scale, and the same (or similar) reference numbers denote the same (or similar) features throughout the Figures.

### DETAILED DESCRIPTION

Provided herein are paper-based packaging films that overcome shortcomings of previously provided films. The paper-based packaging films of the present disclosure are uniquely designed to deliver a critical combination of 1) recyclability (high paper content), 2) ease of package converting and 3) high barrier performance. Additionally, this unique combination of layers and materials allows for an overall high paper content and low thickness, leading to excellent runnability (i.e., high run speed) on packaging equipment.

As described herein, the “total composition” of the paper-based packaging film refers to all materials encompassed therein. The total composition of the paper-based packaging film may include greater than or equal to 80%, greater than or equal to 85%, greater than or equal to 90%, or greater than or equal to 95%, by weight, of the paper component. The total composition of the paper-based packaging film may include less than or equal to 99%, less than or equal to 98%, less than or equal to 97%, or less than or equal to 96%, by weight, of the paper component. For example, the total composition of the paper-based packaging film may comprise in a range of from 85% to 98% of the paper component, by weight, including all values and subranges therebetween. The total composition of the paper-based packaging film may include less than or equal to 5%, less than or equal to 4%, less than or equal to 3%, less than or equal to 2%, or less than or equal to 1%, by weight, of non-compostable materials. The total composition of the paper-based packaging film may include compostable materials that are not the paper component (e.g., a compostable polymer). The total composition of the paper-based packaging film may include less than or equal to 15%, less than or equal to 10%, less than or equal to 5%, less than or equal to 4%, less than or equal to 3%, less than or equal to 2%, or less than or equal to 1%, by weight, of compostable materials that are not the paper component. For example, the total composition of the paper-based packaging film may comprise, by weight, 90% of the paper component, 5% of compostable polymers, and 5% of non-compostable materials. In another example, the total composition of the paper-based packaging film may comprise, by weight, between 80% and 95% of the paper component, between 5% and 20% of compostable polymers, and less than or equal to 5% of non-compostable materials.

The paper-based packaging films described herein include a multilayer barrier film attached to a paper component. In some embodiments, the multilayer barrier film is attached in its entirety to the paper component. As used herein, the term “in its entirety” means that, for example, less than or equal to 1% or less than or equal to 0.5% of the multilayer barrier film is not attached to the paper component. In some embodiments, a portion of the multilayer barrier film is attached to the paper component. As described herein, a portion of the multilayer barrier film is attached to the paper component means that the multilayer barrier film remains, at least, partially attached to the paper component such that the multilayer barrier film remains undamaged and attached to the paper component during production/processing. Additionally, the multilayer barrier film is partially or fully coextensive with the paper component.

The paper-based packaging films may include additional layers. The combination of these materials can be described as a multilayer film (e.g., a structure or a laminate). The term “layer”, as used herein, refers to a building block of films. In other words, a film is built from one or more layers. A layer is a structure of a single material type or a homogeneous blend of materials. A layer may be a single polymer, a blend of materials within a single polymer type or a blend of various polymers. A layer may contain metallic materials and may have additives. Layers may be continuous with the film or may be discontinuous or patterned. Both layers and films have a relatively insignificant thickness (z-direction) as compared to their respective length and width (x-y direction).

As used herein, the term “compostable” refers to materials such as polymers, layers, films or packages that are able to disintegrate and biodegrade at industrial and home composting conditions (12 weeks at 58° C. or 26 weeks at 21° C., respectively) and fulfill industrial compostable standards such as EN 13432-2000, ASTM D6400 “Standard Specification for Labeling of Plastics Designed to be Aerobically Composted in Municipal or Industrial Facilities” or ASTM D6868 “Standard Specification for Labeling of End Items that Incorporate Plastics and Polymers as Coatings or Additives with Paper and Other Substrates Designed to be Aerobically Composted in Municipal or Industrial Facilities”, and home compostable standards such as AS-5810-2010 NF T51800, among others. Compostable polymers may include but are not limited to: polylactic acid (PLA), polybutylene adipate terephthalate (PBAT), and/or polyvinyl alcohol (PVOH).

As used herein, “PLA polymer” or “PLA” is a compostable polymer based on polylactic acid. Commercial examples of PLA polymers are available from Total Corbion and NatureWorks. A layer of a film that comprises PLA may include at least 50%, at least 75% or at least 95% PLA polymer, by weight.

As used herein, “PBAT polymer” or “PBAT” is a compostable biopolymer based on poly(butylene adipate-co-terephthalate). Commercial examples of PBAT biopolymers are available from many suppliers, including but not limited to Mitsubishi, Novamont, Jiangsu Torise Biomaterials Co., and BASF. A layer of a film that comprises PBAT may include at least 50%, at least 75% or at least 95% PBAT polymer, by weight.

As used herein, the term “non-compostable” refers to materials that are not compostable (i.e., materials that are not able to disintegrate and biodegrade at industrial and home composting conditions (12 weeks at 58° C. or 26 weeks at 21° C., respectively). Examples of layers in the paper-based packaging films that may include non-compostable materials include, but are not limited to an adhesive layer, the barrier layer, and/or the lacquer layer. Examples of non-compostable materials include, but are not limited to polyolefins, EVOH, SiOx, vapor deposited metal, inks, and/or overlacquers.

All layers and films described herein have two major surfaces, opposite each other, defined by the x-y plane. The term “outer layer” as used herein refers to one or more layers of a film that are on either major surface of the film, i.e., the layers that are not between two other layers of that film. A film has an exterior surface that becomes the exterior of a package in which the film is used. When formed into a package, the exterior surface of the film is exposed to the environment. A film has an interior surface that becomes the interior of a package in which the film is used. When formed into a package, the interior surface is used for forming seals and is exposed to the packaged product.

One or more of the layers or films of the paper-based packaging films may be partially or fully coextensive with one another.

As used herein, the term “adjacent” means that the items, such as layers of a film, are near each other, with or without intervening material, such as an adhesive layer. As used herein, the term “directly adjacent,” “directly connected” or “in direct contact with” means that the items are in contact with each other, without intervening material.

All layers and films can be produced by any suitable method known to the skilled artisan. Layers and films can be produced by coextrusion, curtain coating, and multi-station lacquering.

There are several challenges associated with paper conversion processes and forming layers/films on paper components. Vacuum coating of paper materials is problematic because the water content of paper causes out-gassing in the vacuum process. Furthermore, fibers given off by the paper contaminate vacuum pumps. Packaging papers are typically fairly thick compared to films-greater than or equal to 40 μm, with polymer films having a thickness in a range of from 10 μm to 20 μm-making paper PVD coating highly in-efficient in the batch-vacuum deposition process.

The surface of the paper component is not ideal for high quality vacuum deposition of barrier layers-even the smoothest paper surfaces are not sufficiently flat to offer a defect free coating for PVD. The normal aspiration of the paper causes cracking of the PVD layer. Additionally, the combination of a PVD layer onto paper also is not ideal for flex crack resistance.

Typical processes for applying PVD barrier layers to paper components include applying a primer coating onto the paper before PVD coating. If the primer coating is water sensitive like EVOH, the coating will be susceptible to adsorption of water through the paper component, causing the paper component to swell and subsequently crack the PVD layer. By having the PVD layer facing the paper component, but between a laminating adhesive and the EVOH support layer, the support layer is protected by the PVD layer from excessive moisture and swelling, thereby also preventing the PVD layer from cracking. PVD coating a primer coated paper is not efficient and suffers from the same issues encountered with PVD coating uncoated paper.

The methods of producing paper-based packaging films described herein advantageously retain the barrier function of the paper-based packaging films' multilayer barrier film, insulating the multilayer barrier film from the negative effects of a paper conversion process.

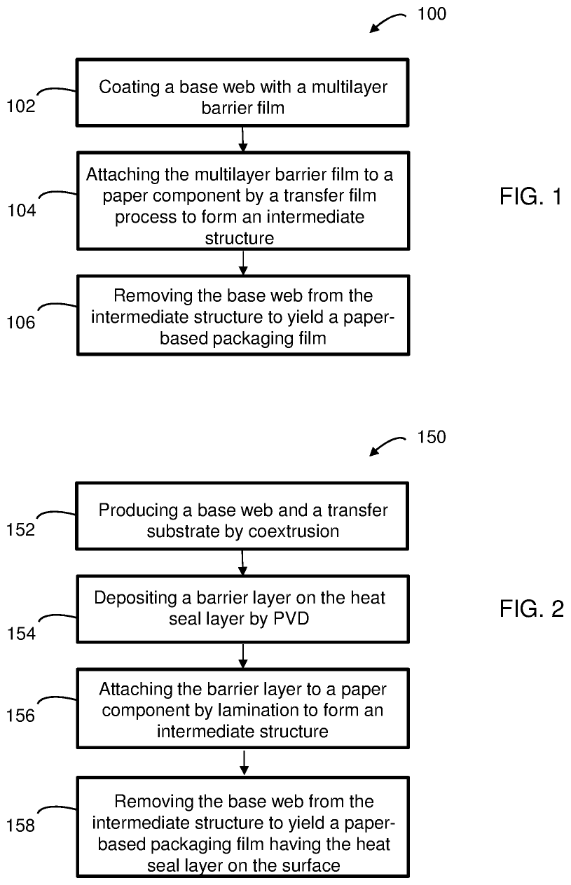

FIG. 1 illustrates a process flow diagram of a method 100 of producing a paper-based packaging film according to one or more embodiments. The method 100 comprises: coating a base web with a multilayer barrier film (operation 102); attaching the multilayer barrier film to a paper component by a lamination process to form an intermediate structure (operation 104); and removing the base web from the intermediate structure to yield a paper-based packaging film (operation 106). In some embodiments, a single transfer operation comprises: the attaching of the multilayer barrier film to the paper component (operation 104), and the removing of the base web from the intermediate structure (operation 106).

In some embodiments, at operation 102, the coating of the base web comprises: depositing a transfer substrate on the base web and depositing a barrier layer by physical vapor deposition (PVD) on the transfer substrate.

In some embodiments, at operation 104, the attaching of the multilayer barrier film to the paper component comprises disposing an adhesive layer between the multilayer barrier film and the paper component.

In some embodiments, a second paper component is attached to the paper-based packaging film by a second lamination process. In specific embodiments where the paper-based packaging film has the paper component and the second paper component, the paper component is attached to the top surface of the multilayer barrier film by way of the adhesive layer. In specific embodiments where the paper-based packaging film has the paper component and the second paper component, the second paper component is attached to the bottom surface of the multilayer barrier film by disposing an adhesive layer between the bottom surface of the multilayer barrier film and the second paper component.

In specific embodiments, the second paper component may have the same or similar properties as the “paper component” described herein. In specific embodiments, the second lamination process may have the same or similar properties or require the same process conditions as the “lamination process” described herein.

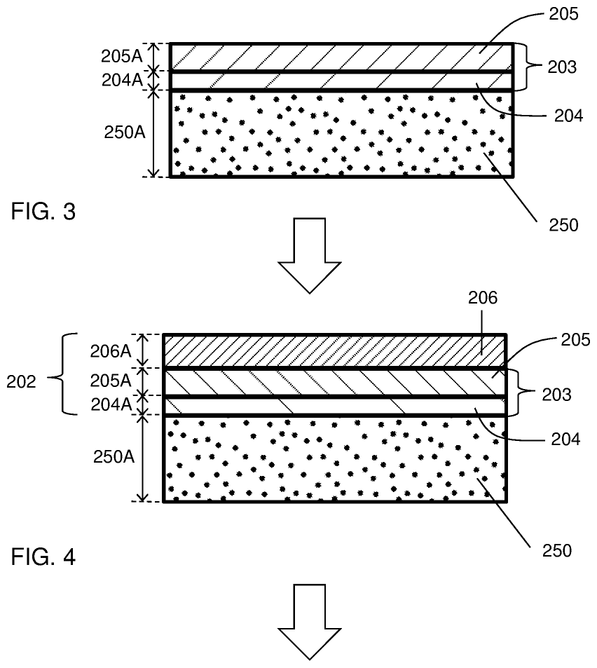

FIG. 2 illustrates a process flow diagram of a method 150 of producing a paper-based packaging film according to one or more embodiments. The method 150 comprises: producing a base web and a transfer substrate by coextrusion (operation 152); depositing a barrier layer on the heat seal layer by physical vapor deposition (PVD) (operation 154); attaching the barrier layer to a paper component by a lamination process to form an intermediate structure (operation 156); and removing the base web from the intermediate structure and yield a paper-based packaging film having the heat seal layer on the surface (operation 158). In operation 158, separation occurs between the base web and the heat seal layer. The transfer substrate of the coextrusion comprises a heat seal layer. The transfer substrate of the coextrusion may include other layers, such as a lacquer layer.

In some embodiments, a single transfer operation comprises: the attaching of the barrier layer to the paper component by the lamination process to form the intermediate structure (operation 156), and the removing of the base web from the intermediate structure (operation 158).

The methods described herein advantageously leave the PVD deposited barrier layer undamaged and attached to the heat seal layer (ultimately, attached to the paper component) upon the removing of the base web from the intermediate structure (operation 158). In specific embodiments, the PVD deposited barrier layer is advantageously attached to the heat seal layer (ultimately, attached to the paper component) upon the removing of the base web from the intermediate structure (operation 158) in its entirety.

Advantageously, the methods described herein allow for each of the layers added to the paper component to be very thin. By utilizing a PVD barrier layer, attaching the multilayer barrier film to the paper component by adhesive lamination and removal of the base film, the adhesive layer, the barrier layer and the heat seal layer (and the lacquer layer, if present), may be very thin, therefore contributing less material to the overall structure. In this way, the paper-based packaging film remains recyclable, due to the high paper component content, while benefiting from a high-performance barrier layer and a sealing layer.

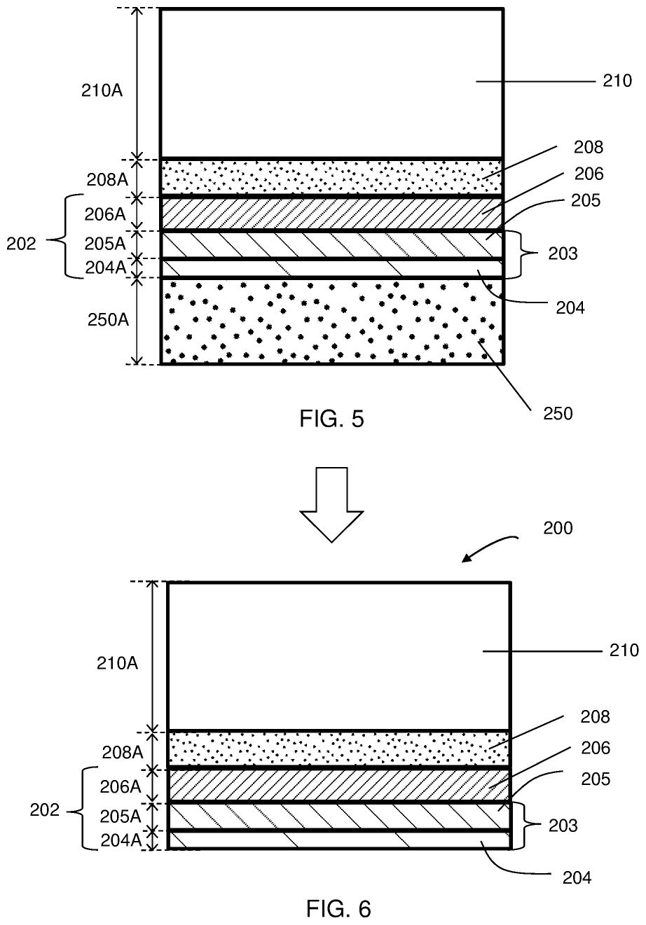

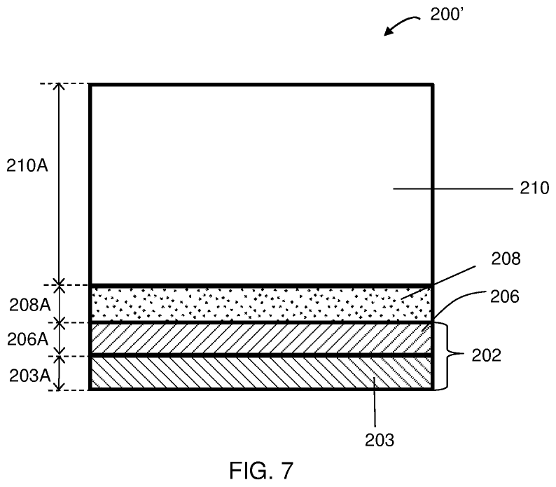

FIGS. 3, 4, and 5 are schematic cross-sectional views of film structures in intermediate steps of forming a paper-based packaging film shown in FIG. 6. FIG. 7 is a schematic cross-sectional view of another embodiment of the paper-based packaging film. The paper-based packaging film illustrated in FIGS. 6 and 7 may be formed by method 100 and/or method 150.

FIG. 3 illustrates a transfer substrate 203 on a base web 250. The base web 250 comprises one or more of: an oriented polyethylene (OPE) film, an oriented polyethylene terephthalate (OPET) film, an oriented polypropylene (OPP) film, and/or an oriented polyamide (OPA) film.

In the illustrated embodiment of FIG. 3, the transfer substrate 203 comprises a heat seal layer 204 and a lacquer layer 205. In some embodiments, the heat seal layer 204 comprises a non-oriented film. In some embodiments, the heat seal layer 204 comprises a compostable polymer. In some embodiments, the heat seal layer 204 comprises one or more of: polylactic acid (PLA), polybutylene adipate terephthalate (PBAT), and/or polyvinyl alcohol (PVOH).

FIG. 4 illustrates the result of operation 156 of method 150 applied to the film of FIG. 3, deposing a barrier layer 206 on the transfer substrate 203 comprising the heat seal layer 204 and the lacquer layer 205. The transfer substrate 203 and the barrier layer 206 deposited on the transfer substrate 203 form a multilayer barrier film 202. In some embodiments, the heat seal layer 204 is directly connected to the barrier layer 206, such that there are no intervening elements/layers/films between the heat seal layer 204 and the barrier layer 206 (i.e., lacquer layer 205 is not present).

FIG. 5 illustrates the result of operation 104 of method 100 and operation 156 of method 150: attaching the multilayer barrier film 202 of the structure shown in FIG. 4 to a paper component 210 to form an intermediate structure. In some embodiments, at operation 104, the attaching of the multilayer barrier film 202 to the paper component 210 comprises disposing an adhesive layer 208 between the multilayer barrier film 202 and the paper component 210.

FIG. 6 illustrates the result of operation 106 of method 100 and operation 158 of method 150: removing the base web 250 from the intermediate structure (illustrated in FIG. 5) to expose the heat seal layer 204 and yield a paper-based packaging film 200.

FIG. 7 illustrates a schematic cross-sectional view of a paper-based packaging film 200′ having a transfer substrate 203. In one or more embodiments, the transfer substrate 203 comprises a single layer. In some embodiments, the transfer substrate 203 comprises a heat seal layer having the same or similar properties as heat seal layer 204. In the illustrated embodiment of FIG. 7, the transfer substrate 203 has a barrier layer 206 deposited thereon by physical vapor deposition (PVD), the transfer substrate 203 and the barrier layer 206 defining a multilayer barrier film 202. FIG. 7 also illustrates an adhesive layer 208 between the multilayer barrier film 202 and the paper component 210.

Each of the layers/films illustrated in FIGS. 3-7 have a thickness measured in the z-direction. In some embodiments, the heat seal layer 204 has a thickness 204A in a range of from 2 μm to 10 μm. In some embodiments the heat seal layer 204 has a thickness 204A in a range of from 2 μm to 8 μm, or in a range of from 2 μm to 6 μm. In some embodiments, the lacquer layer 205 has a thickness 205A in a range of from 1 μm to 2 μm. In some embodiments, the transfer substrate 203 comprising the heat seal layer 204 and the lacquer layer 205 has a thickness in a range of from 3 μm to 12 μm. In some embodiments, the base web 250 has a thickness 250A in a range of from 6 μm to 50 μm.

In some embodiments, the multilayer barrier film 202 and the adhesive layer 208 have a combined thickness of less than or equal to 10 μm. In some embodiments, the combined thickness is in a range of from 4 μm to 8 μm.

Referring again to the paper component, the paper component is an outer layer of the paper-based packaging film that is located at an exterior surface of the paper-based packaging film. In some embodiments, the paper component includes additional components adjacent to or on the exterior surface of the paper component, such as ink or over lacquer. These additional components may cover a portion of the exterior surface or the entire exterior surface.

The “paper component” may be any type of paper that can be processed in a paper recycling (repulpability) process. As used herein, the term “paper component” may be described with respect to an amount of cellulose fibers in the paper component. For example, the paper component comprises or may consists essentially of cellulose fibers. As used in this context, “consisting essentially of” means that the total composition of the paper component includes greater than or equal to 95%, greater than or equal to 98%, greater than or equal to 99%, greater than or equal to 99.9% or 100% cellulose fibers. In some cases the paper component may contain up to 20% mineral filler by weight and correspondingly an amount greater than or equal to 80% cellulose fibers.

Accordingly, in embodiments where a total composition of the paper-based packaging film comprises greater than or equal to 80%, greater than or equal to 85%, greater than or equal to 90% or greater than or equal to 95%, by weight, of the paper component, the total composition of the paper-based packaging film comprises greater than or equal to 80%, greater than or equal to 85%, greater than or equal to 90% or greater than or equal to 95%, by weight, of the cellulose fibers.

In some embodiments, the paper component has a basis weight in a range of from 30 g/m² to 360 g/m², including all values and subranges therebetween, including in a range of from 30 g/m² to 100 g/m², or in a range of from 30 g/m² to 70 g/m². Lower paper component weight is possible, while retaining easy recyclability, because the additional components are minimized. Examples of paper-components that may be useful in the paper-based packaging films include, but are not limited to, kraft paper, parchment, and bleached paper. The paper component may be coated (i.e., clay coated) or uncoated. Examples of commonly used paper in packaging that would be acceptable in the paper-based packaging films described herein include machine glazed bleached kraft paper (MGBK), one-side clay-coated paper (C1S) and two-side clay-coated paper (C2S) although less common papers providing improved mechanical or barrier performance by using specialty fibers or additives could also be a part of the paper-based packaging films described in this application. Clay coated papers can contain up to 15 gsm of coating resulting in a significant fraction of latex being applied. This usually means clay coated papers are not considered compostable unless the latex used is a compostable polymer. In embodiments where the paper component is coated, the total composition of the paper component has greater than or equal to 95%, greater than or equal to 98%, greater than or equal to 99%, greater than or equal to 99.9%, or 100% cellulose fibers.

As used herein, the term “basis weight” is used to refer to the amount of material by weight is present in a predetermined area of a film or layer. Typically, the area defined is a square meter, but any area can be used. The area is defined in the length-width (i.e., x-y direction) of the film or layer. A material of a given thickness (z-direction) and density, has a specific weight when covering a defined area (i.e., a square meter). Basis weight is a commonly used measurement of weight for paper because the density of paper can vary widely. Stated differently, measuring paper by thickness in the z-direction can be difficult. Materials that are applied in discontinuous layers, such as a patterned material, can also be defined by basis weight. In the case of patterns, the basis weight refers to the amount of material by weight that is present when covering a defined area. The use of basis weight to measure weight of materials such as paper and patterned materials is common in the film converting industry.

In some embodiments, the paper-based packaging film comprises a multilayer barrier film attached to the paper component. In some embodiments, the paper-based packaging film comprises an adhesive layer attaching the multilayer barrier film to the paper component.

In some embodiments, the multilayer barrier film comprises a transfer substrate and a barrier layer deposited thereon by physical vapor deposition (PVD). In some embodiments, the transfer substrate comprises a heat seal layer, and optionally a lacquer layer.

In some embodiments, the transfer substrate further comprises the lacquer layer. In some embodiments, the lacquer layer comprises one or more of: polyurethane (PU), polyvinyl alcohol (PVOH), and/or ethylene vinyl alcohol (EVOH).

In some embodiments, the barrier layer comprises one or more of: a metal, a metal oxide, and/or an inorganic oxide. In some embodiments, the barrier layer comprises one or more of: aluminum oxide (AIOx) and/or silicon oxide (SiOx). The barrier layer may provide reduced transmission of oxygen, moisture or both oxygen and moisture.

The barrier material may be multi-layer and contain different layers of barrier materials. The barrier material may be a blend of multiple barrier materials.

In some embodiments, the paper-based packaging film containing the multilayer barrier film described herein has an average oxygen transmission rate (OTR) value that is less than or equal to 5 cm³/m²/day, less than or equal to 1 cm³/m²/day or less than or equal to 0.5 cm³/m²/day measured according to ASTM F1927 using conditions of 1 atmosphere, 23° C. and 50% RH. In some embodiments, the paper-based packaging film containing a barrier material coated on a polymeric film has an average moisture vapor transmission rate (MVTR) value (sometimes referred to as water vapor transmission rate (WVTR)) that is less than or equal to 1 g/m²/day, measured according to ASTM F1249 using conditions of 1 atmosphere, 38° C. and 90% RH.

The paper-based packaging film may include an adhesive layer bonding the paper component to the barrier material. The adhesive layer may be in direct contact with the paper component. The adhesive layer may be in direct contact with the multilayer barrier film. The adhesive layer may be applied by any known means of web-to-web lamination, such as dry bond lamination, wet bond lamination or heat lamination. The adhesive layer may have a dry basis weight (i.e., after solvent removal) of between of between 0.5 g/m² and 4.0 g/m².

Embodiments of the disclosure advantageously provide paper-based packing films including an adhesive layer that is water sensitive. As used herein, the term “water sensitive” means that upon prolonged exposure to or immersion in liquid water, the adhesive layer loses its adhesive and/or cohesive properties, thus enabling the delamination (i.e., separation) of the paper component from the rest of the paper-based packaging film structure during a repulping process. Examples of materials that may be used within an adhesive layer between the paper component and the multilayer barrier film include, but are not limited to, latex/casein blends, starch, sugar derivatives, cellulose, amino resin, (poly) acrylate, polyvinyl alcohol (PVOH), polyvinyl acetate, polyacrylic acid, maleic acid-modified ethylene copolymers, methylcellulose, carboxy-methylcellulose, carboxy-functional polyesters, polyethylene succinate, polybutylene succinate, ionomers or hydrophilic polyurethane.

As mentioned previously, the paper-based packaging film may also include ink located on the exterior surface of the paper-based packaging film. The type of ink and amount of ink can be varied within ranges agreeable with local paper recycling guidelines.

The paper-based packaging films can be advantageously used to form packages. The term “package” is used herein to describe an article that may house an object (i.e., a product), the article formed by bonding one or more paper-based packaging films or other packaging components to itself or each other around a periphery, thus forming a package interior space. A “packaged product” refers to the one or more packaging components forming a hermetically sealed package and the product therein. As used herein, hermeticity refers to a seal or sealed package that is completely closed and essentially airtight. Hermetically sealed packages generally have a need for storage and package integrity over a period of time that is greater than a few days. Package integrity includes a consistent appearance, maintenance of barrier properties, maintenance of lamination bonds, and maintenance of seals.

The product may be any type of food, beverage, pharmaceutical or other medical aid, nutraceutical, consumer good or industrial good. The product may be fluid in nature. Examples of products include, but are not limited to, condiments such as ketchup, mustard, mayonnaise, or relish, pudding, yogurt, cheese sauce, nut butter, jam/jelly, dairy or non-dairy creamer, guacamole, applesauce, pureed baby food, baby formula, nutritional drinks/shakes, beverage or supplement concentrates, cough syrup, fish oil, lotion, salve/ointment, personal care items, soap/detergent, or solvent.

As mentioned, the product may be fluid in nature, or may have a fluid component. The product may be water-based (i.e., has water as a medium or main ingredient) or oil-based (i.e., has oil as a medium or main ingredient). The paper-based packaging film described herein may be particularly useful in containing an acidic product for a significant shelf-life (days, weeks or months) with minimal loss of barrier. The product may have a pH below 7, below 6, below 5, below 4 or even below 3.

The packaged products disclosed herein include a package formed from at least one paper-based packaging film and optionally other components. In some embodiments of the packaged product, the entire package is formed from a single paper-based packaging film that has been folded over and sealed to itself (i.e., a flow wrap or stick pack configuration).

In each of the packaged products, the first surface of the paper-based packaging film is facing away from the product, exposed to the outside environment, and the second surface of the compostable multilayer film is facing toward the product, exposed to the product and the internal environment. The paper component may be at or near the first surface, facing away from the packaged product. The second surface may comprise the heat seal layer.

The paper-based packaging films disclosed herein are particularly useful for packaged product which have a small size, such as 6″ by 9″, 5″ by 7″, 5″ by 5″, 3″ by 3″, 3″ by 2″, etc., as these types of packages are difficult to collect and/or sort for recycling. Small packages and small packaging components may be better suited to compostable end-of-life solutions, as opposed to recycling.

The paper-based packaging films disclosed herein are particularly useful for packaged product formats and/or product types which result in significant product residue remaining in the package after consumer use. The packaged product may be of a style or configuration that inhibits/prohibits complete removal of the product. The packaged product may be of a style or configuration that inhibits/prohibits cleaning the package after use. The product packaged may be one that tends to cling or adhere to the package. In these cases, the package should not be recycled because the product residue contaminates the recycling process. In these cases, composting is an excellent solution as the product residue may promote the decomposition process.

In some embodiments of the packaged product, a paper-based packaging film is sealed to another paper-based packaging film (i.e., a sachet configuration). In some embodiments of the packaged product, a paper-based packaging film is a lidding component which is sealed to a formed container such as a cup or tray. Packages that include components that are not according to the paper-based packaging films disclosed herein may also be compostable, such that the entire package is compostable. In some embodiments, the package includes components that are not compostable but can be separated from the portions that are compostable for proper disposal.

The heat seal layer of the paper-based packaging film may have a composition that will allow for the formation of a hermetically-sealed package. In some embodiments, the heat seal layer comprises a non-oriented film (i.e., the heat seal layer is part of a non-oriented film). In some embodiments, the heat seal layer comprises a compostable polymer. In some embodiments, the heat seal layer comprises one or more of: polylactic acid (PLA), polybutylene adipate terephthalate (PBAT), and/or polyvinyl alcohol (PVOH).

The heat seal layer allows two or more surfaces to be bonded together by application of both heat and pressure. Heat sealing is a well-known and commonly used process for creating packages and is familiar to those skilled in the art. Without intending to be bound by theory, during heat sealing, the heat seal layer softens due to the application of heat, allowing formation of a heat seal bond. Since the heat must be driven through the entire paper-based packaging film to raise the temperature of the sealable material, and the paper component often absorbs much of the heat, it is advantageous if the heat sealable material softens and seals at a relatively low temperature. Lower seal initiation temperature (SIT) enables faster packaging line speeds. For example, some embodiments of the paper-based packaging film may include a heat sealable material that exhibits an SIT of less than or equal to 110° C., less than or equal to 100° C., or less than or equal to 90° C. Possible heat sealable materials may include, but are not limited to, acrylate copolymers, PET, PE, PP or hot melts (wax based).

The heat seal layer is applied at a thickness that allows for hermetic sealing. In some embodiments, the heat seal layer may be applied at a basis weight of greater than or equal to 1 g/m² or greater than or equal to 3 g/m². In other embodiments, the heat seal layer may be applied at a basis weight of less than or equal to 8 g/m², less than or equal to 9 g/m², or less than or equal to 10 g/m². For example, the heat seal layer may have a basis weight in a range of from about 1 g/m² to about 10 g/m², or in a range of from about 3 g/m² to about 9 g/m².

The disclosure is now described with reference to the following examples.

### Examples

Example 1 is a prophetic example based on the paper-based packaging films as described above. Example 1 could be produced by laminating a 67 g/m² paper component to a multilayer barrier film. The multilayer barrier film may be produced by applying a 1.3 g/m² PVOH-based barrier lacquer layer to a 12 μm polyester film. The lacquer may be applied in a manner such that adhesion to the polyester film is low, e.g., by omitting adhesion promoters in the lacquer layer. After lacquering, the PVOH-based barrier lacquer layer could be SiOx-coated with 50 mg/m² SiOx. The SiOx coated layer may be laminated with a 3 g/m² layer of a suitable adhesive to the paper to form an intermediate structure. The 12 μm polyester film could then be removed to yield a paper-based packaging film having a structure of 67 g/m²//Adhesive 3 g/m²//SiOx coating 0.05 g/m²//PVOH coating 1.3 g/m². The Example 1 paper-based packaging film would have a total composition including about 94% by weight of the paper component and about 4% by weight of non-compostable materials.

The paper-based packaging film of Example 1 could be lacquered with 1.5 g/m² of heat seal layer and/or lacquer layer, for use as a packaging film. The heat seal layer could be added in a pattern such that the non-compostable material level is minimized and remains below 5%.

Example 2 is a prophetic example based on the paper-based packaging films as described above. Example 2 could be produced by first coextruding a 20 μm polyethylene/6 μm amorphous PLA/4 μm PVOH multilayer film. In a second step the PE/aPLA/PVOH film is SiOx-coated with 50 mg/m² SiOx on the PVOH surface. Finally, the SiOx coated surface of the film is laminated to paper (67 gsm) with a suitable adhesive and the PE layer is stripped away. The final structure of the paper-based packaging film is: paper 67 g/m²//adhesive 3 g/m²//SiOx coating 0.05 g/m²//PVOH coating 3.0 g/m²//amorphous PLA heat seal layer 7.5 g/m². The Example 2 paper-based packaging film would have a total composition including about 83% by weight of the paper component and about 4% by weight of non-compostable materials.

Example 3 is a prophetic example based on the paper-based packaging films as described above. Example 3 could be produced by first coextruding a 25 μm polyethylene/8 μm amorphous PLA multilayer film. In a second step the PE/aPLA film is SiOx-coated with 50 mg/m² SiOx on the aPLA surface. Finally, the SiOx coated surface of the film is laminated to paper (67 gsm) with a suitable adhesive and the PE layer is stripped away. The final structure of the paper-based packaging film is: paper 67 g/m²//adhesive 3 g/m²//SiOx coating 0.05 g/m²//amorphous PLA heat seal layer 10.0 g/m². The Example 3 paper-based packaging film would have a total composition including about 84% by weight of the paper component and about 4% by weight of non-compostable materials.

Examples 4, 5 and 6 are paper-based packaging films produced by the processes disclosed herein. The films were produced by coextruding a base web and a heat seal layer (i.e., a transfer substrate), depositing a PVD layer of aluminum (negligible weight) as the barrier layer onto the heat seal layer, laminating to a paper component and removing the base web. The structures of the films produced are shown in Table 1.

TABLE 1
Structure details of Examples 4, 5 and 6

| | | | % non- |
|---|---|---|---|
| | | % paper | compostable |
| | | component | material |
| Ex. | Structure | (by weight) | (by weight) |
| 4 | 65 g/m² paper/2 g/m² compostable | 91% | <0.1% |
| | adhesive/aluminum/6.5 g/m² PLA | | |
| | (Ingeo ™ Biopolymer 4060D available | | |
| | from NatureWorks) | | |
| 5 | 65 g/m² paper/2 g/m² compostable | 91% | <0.1% |
| | adhesive/aluminum/6.5 g/m² | | |
| | PLA + PBAT blend (ecovio ® T2308 | | |
| | available from BASF) | | |
| 6 | 65 g/m² paper/2 g/m² compostable | 89% | <0.1% |
| | adhesive/aluminum/4 g/m² BVOH | | |
| | (Nichigo G-Polymer ™ OKS-8095-P | | |
| | available from Soarus)/4 g/m² PBAT | | |
| | (Ecoflex ® F Blend C 1200 available | | |
| | from BASF) | | |

### Embodiments

Embodiment 1: A paper-based packaging film comprising: a paper component attached to a multilayer barrier film comprising a compostable polymer; wherein a total composition of the paper-based packaging film comprises greater than or equal to 80%, by weight, of the paper component and less than or equal to 5%, by weight, of non-compostable materials.

Embodiment 2: The paper-based packaging film of Embodiment 1, wherein the paper component has a basis weight in a range of from 30 g/m² to 360 g/m².

Embodiment 3: The paper-based packaging film of any previous Embodiment, further comprising an adhesive layer attaching the multilayer barrier film to the paper component.

Embodiment 4: The paper-based packaging film of any previous Embodiment, wherein the multilayer barrier film comprises a transfer substrate and a barrier layer deposited thereon by physical vapor deposition (PVD).

Embodiment 5: The paper-based packaging film of any one of Embodiments 1-4, wherein the transfer substrate comprises a heat seal layer.

Embodiment 6: The paper-based packaging film of any one of Embodiments 1-5, wherein the heat seal layer comprises a non-oriented film.

Embodiment 7: The paper-based packaging film of any one of Embodiments 1-6, wherein the heat seal layer comprises a compostable polymer.

Embodiment 8: The paper-based packaging film of any one of Embodiments 1-7, wherein the compostable polymer is selected from the group consisting of: polylactic acid (PLA), polybutylene adipate terephthalate (PBAT) polybutylene succinate (PBS), polyhydroxyalkanoate (PHA).

Embodiment 9: The paper-based packaging film of any one of Embodiments 5-8, wherein the heat seal layer has a thickness in a range of from 2 μm to 10 μm.

Embodiment 10: The paper-based packaging film of any one of Embodiments 5-9, wherein the heat seal layer is directly connected to the barrier layer.

Embodiment 11: The paper-based packaging film of any one of Embodiments 5-10, wherein the transfer substrate further comprises a lacquer layer, the lacquer layer comprising one or more of: polyurethane (PU), polyvinyl alcohol (PVOH), and/or ethylene vinyl alcohol (EVOH).

Embodiment 12: The paper-based packaging film of Embodiment 11, wherein the lacquer layer has a thickness in a range of from 1 μm to 2 μm.

Embodiment 13: The paper-based packaging film of any one of Embodiments 4-12, wherein the barrier layer comprises one or more of: a metal, a metal oxide, and/or an inorganic oxide.

Embodiment 14: The paper-based packaging film of Embodiment 13, wherein the barrier layer comprises one or more of: aluminum oxide (AIOx) and/or silicon oxide (SiOx).

Embodiment 15: The paper-based packaging film of any one of Embodiments 5-14, wherein the multilayer barrier film and the adhesive layer have a combined thickness of less than or equal to 10 μm.

Embodiment 16: The paper-based packaging film of Embodiment 15, wherein the combined thickness is in a range of from 4 μm to 8 μm.

Embodiment 17: The paper-based packaging film of any previous Embodiment, wherein the total composition of the paper-based packaging film comprises greater than or equal to 85%, by weight, of the paper component and less than or equal to 5%, by weight, of the non-compostable materials.

Embodiment 18: A method of producing a paper-based packaging film, the method comprising: coating a base web having a thickness in a range of from 6 μm to 50 μm with a multilayer barrier film comprising a compostable polymer; attaching the multilayer barrier film to a paper component by a lamination process to form an intermediate structure; and removing the base web from the intermediate structure to yield the paper-based packaging film, wherein a total composition of the paper-based packaging film comprises greater than or equal to 80%, by weight, of the paper component and less than or equal to 5%, by weight, of non-compostable materials.

Embodiment 19: The method of Embodiment 18, wherein a single transfer operation comprises: the attaching of the multilayer barrier film to the paper component, and the removing of the base web from the intermediate structure.

Embodiment 20: The method of any one of Embodiments 18 and 19, wherein the base web comprises one or more of: oriented polyethylene (OPE) film, an oriented polyethylene terephthalate (OPET) film, an oriented polypropylene (OPP) film, and/or an oriented polyamide (OPA) film.

Embodiment 21: The method of any one of Embodiments 18-20, wherein the coating of the base web comprises: depositing a transfer substrate on the base web, and depositing a barrier layer by physical vapor deposition (PVD) on the transfer substrate, a combination of the barrier layer and the transfer substrate defining the multilayer barrier film.

Embodiment 22: The method of any one of Embodiments 18-21, wherein the attaching of the multilayer barrier film to the paper component comprises disposing an adhesive layer between the multilayer barrier film and the paper component.

Embodiment 23: The method of Embodiment 21, wherein the transfer substrate comprises a heat seal layer, and optionally a lacquer layer.

Embodiment 24: The method of Embodiment 23, wherein the heat seal layer comprises a non-oriented film.

Embodiment 25: The method of any one of Embodiments 23-24, wherein the heat seal layer comprises a compostable polymer.

Embodiment 26: The method of any one of Embodiments 23-25, wherein the heat seal layer comprises one or more of: polylactic acid (PLA), polybutylene adipate terephthalate (PBAT) polybutylene succinate (PBS), polyhydroxyalkanoate (PHA), polyethylene vinyl alcohol (EVOH) and/or polyvinyl alcohol (PVOH).

Embodiment 27: The method of any one of Embodiments 23-26, wherein the heat seal layer has a thickness in a range of from 2 μm to 10 μm.

Embodiment 28: The method of any one of Embodiments 23-27, wherein the heat seal layer is directly connected to the barrier layer.

Embodiment 29: The method of Embodiment 23, wherein the transfer substrate further comprises the lacquer layer, the lacquer layer comprising one or more of: polyurethane (PU), polyvinyl alcohol (PVOH), and/or ethylene vinyl alcohol (EVOH).

Embodiment 30: The method of any one of Embodiments 21-29, wherein the barrier layer comprises one or more of: aluminum oxide (AIOx) and/or silicon oxide (SiOx).

Embodiment 31: The method of any one of Embodiments 18-30, wherein the total composition of the paper-based packaging film comprises greater than or equal to 85%, by weight, of the paper component and less than or equal to 5%, by weight, of the non-compostable materials.

Embodiment 32: A method of producing a paper-based packaging film, the method comprising: producing a base web and a heat seal layer by coextrusion; depositing a barrier layer on the heat seal layer by physical vapor deposition (PVD); attaching the barrier layer to a paper component by a lamination process to form an intermediate structure; and removing the base web from the intermediate structure to expose the heat seal layer and yield the paper-based packaging film, wherein a total composition of the paper-based packaging film comprises greater than or equal to 80%, by weight, of the paper component.

Embodiment 33: A paper-based packaging film comprising: a multilayer barrier film comprising a transfer substrate and a barrier layer deposited by physical vapor deposition (PVD); and an adhesive layer attaching a paper component to the multilayer barrier film, wherein the transfer substrate comprises a heat seal layer, the heat seal layer having a thickness in a range of from 2 μm to 8 μm, the barrier layer comprises one or more of: a metal, aluminum oxide (AIOx) and/or silicon oxide (SiOx), and a total composition of the paper-based packaging film comprises greater than or equal to 85%, by weight, of the paper component.

Embodiment 34: The paper-based packaging film of Embodiment 33, wherein the heat seal layer comprises a compostable polymer.

Embodiment 35: The paper-based packaging film of any one of Embodiments 33-34, wherein the heat seal layer comprises a non-oriented film.

Embodiment 36: The paper-based packaging film of any one of Embodiments 33-35, the heat seal layer comprises one or more of: polylactic acid (PLA), polybutylene adipate terephthalate (PBAT), and/or polyvinyl alcohol (PVOH).

1. A paper-based packaging film comprising:
a paper component attached to a multilayer barrier film, the multilayer barrier film comprising a compostable polymer, a transfer substrate and a barrier layer deposited on the transfer substrate by physical vapor deposition (PVD);
wherein a total composition of the paper-based packaging film comprises greater than or equal to 80%, by weight, of the paper component and less than or equal to 5%, by weight, of non-compostable materials.

2. The paper-based packaging film of claim 1, wherein the paper component has a basis weight in a range of from 30 g/m² to 360 g/m².

3. The paper-based packaging film of claim 1, further comprising an adhesive layer attaching the multilayer barrier film to the paper component.

4. (canceled)

5. The paper-based packaging film of claim 1, wherein the transfer substrate comprises a heat seal layer.

6. The paper-based packaging film of claim 5, wherein the heat seal layer comprises a non-oriented film.

7. The paper-based packaging film of claim 5, wherein the heat seal layer comprises the compostable polymer.

8. The paper-based packaging film of claim 1, wherein the compostable polymer is selected from the group consisting of: polylactic acid (PLA), polybutylene adipate terephthalate (PBAT) polybutylene succinate (PBS), polyhydroxyalkanoate (PHA).

9. The paper-based packaging film of claim 5, wherein the heat seal layer has a thickness in a range of from 2 μm to 10 μm.

10. The paper-based packaging film of claim 5, wherein the heat seal layer is directly connected to the barrier layer.

11. The paper-based packaging film of claim 5, wherein the transfer substrate further comprises a lacquer layer located between the heat seal layer and the barrier layer, the lacquer layer comprising one or more of: polyurethane (PU), polyvinyl alcohol (PVOH), and/or ethylene vinyl alcohol (EVOH).

12. The paper-based packaging film of claim 11, wherein the lacquer layer has a thickness in a range of from 1 μm to 2 μm.

13. The paper-based packaging film of claim 1, wherein the barrier layer comprises one or more of: a metal, a metal oxide, and/or an inorganic oxide.

14. The paper-based packaging film of claim 13, wherein the barrier layer comprises one or more of: aluminum oxide (AIOx) and/or silicon oxide (SiOx).

15. The paper-based packaging film of claim 5, wherein the multilayer barrier film and the adhesive layer have a combined thickness of less than or equal to 10 μm.

16. The paper-based packaging film of claim 15, wherein the combined thickness is in a range of from 4 μm to 8 μm.

17. The paper-based packaging film of claim 1, wherein the total composition of the paper-based packaging film comprises greater than or equal to 85%, by weight, of the paper component and less than or equal to 5%, by weight, of the non-compostable materials.

18.-32. (canceled)

33. A paper-based packaging film comprising:
a multilayer barrier film comprising a transfer substrate and a barrier layer deposited by physical vapor deposition (PVD); and
an adhesive layer attaching a paper component to the multilayer barrier film,
wherein the transfer substrate comprises a heat seal layer, the heat seal layer having a thickness in a range of from 2 μm to 8 μm,
the barrier layer comprises one or more of: a metal, aluminum oxide (AIOx) and/or silicon oxide (SiOx), and
a total composition of the paper-based packaging film comprises greater than or equal to 85%, by weight, of the paper component.

34. The paper-based packaging film of claim 33, wherein the heat seal layer comprises a compostable polymer.

35. The paper-based packaging film of claim 33, wherein the heat seal layer comprises a non-oriented film.

36. The paper-based packaging film of claim 33, the heat seal layer comprises one or more of: polylactic acid (PLA), polybutylene adipate terephthalate (PBAT) polybutylene succinate (PBS), polyhydroxyalkanoate (PHA), and/or polyvinyl alcohol (PVOH).

37. (canceled)
